(19) United States
(12) Patent Application Publication
(10) Pub. No.: US 2007/0020070 A1
(43) Pub. Date: Jan. 25, 2007

(54) Positioner docking device for a medical imaging apparatus

(75) Inventor: Narendar Venkatachalapathy, Bangalore (IN)

Correspondence Address: INTERNATIONAL PATENT COUNSELORS, P.O. BOX 2843, SPOKANE, WA, 99220-2843, US

(73) Assignee: General Electric Company, Schenectady, NY (US)

(21) Appl. No.: 11/174,356

(22) Filed: Jul. 2, 2005

(51) Int. Cl. B65G 67/00

(52) U.S. Cl. 414/401

(57) ABSTRACT

In some embodiments, a positioner docking device for a medical imaging apparatus comprises at least one first docking part having at least one first guiding surface disposed in a gantry, and at least one locking recess disposed in the first guiding surface. In some embodiments, at least one second docking part having at least one second guiding surface is disposed in a positioner. In some embodiments, at least one locking member coupled to at least one energizing means is disposed in the second guiding surface. In some embodiments, the first guiding surface and the second guiding surface are configured movable towards each other for mutual engagement, wherein upon engagement, the locking member is locked onto the locking recess for docking the positioner on to the gantry.

### FIELD OF THE INVENTION

This invention relates generally to docking devices, and more particularly to, a docking device for a mobile patient positioner in a medical imaging apparatus.

### BACKGROUND OF THE INVENTION

Generally, in a medical imaging apparatus, a docking device is used for fixedly coupling a mobile patient positioner to a gantry at the time of medical imaging. Examples of a medical imaging apparatus include a Magnetic Resonance Imaging (MRI) apparatus, a Computed Tomography (CT) scanner, a vascular imaging apparatus, etc. One example of a mobile patient positioner includes a trolley configured for carrying a patient in substantially horizontal posture for medical imaging.

Typically, in a hospital or a clinical facility, for intensively using the medical imaging apparatus, patient preparation is carried out on multiple mobile patient positioners at a location away from the gantry, and medical imaging is carried out after patient preparation by docking the mobile patient positioners one by one on to the gantry.

A known configuration of a docking device for a mobile patient positioner in a medical imaging apparatus includes a hook mechanism comprising at least one hook member and at least one engaging member. The hook member is provided in the mobile patient positioner and the engaging member is provided in the gantry. At least a pair of pedals is provided on the mobile patient positioner, which when operated by a user, effects engagement and disengagement of the hook member with the engaging member, and thereby respectively result in docking and undocking of the mobile patient positioner from the gantry.

One example of a docking operation includes pushing the mobile patient positioner towards the gantry, and operating one of a pair of pedals to lock the hook member on to the engaging member. Undocking operation is carried out by operating the other pedal to release the hook member from the engaging member.

Although the configuration of the hook mechanism enables easy docking and undocking by an operator, the work of setting appropriate tension between the pedal and the hook is very cumbersome. Furthermore, a vibration or a side load on the hook mechanism, or a deformation e.g. elongation of hook, may cause unlocking of the hook member and the engaging member, thereby resulting in improper patient positioning and reduced patient safety.

International Patent Publication No. WO 03/041577 A1 entitled “Docking means for medical system comprising examination device and patient support device” by Koninklijke Philips Electronics N.V, discloses a docking device, wherein the device includes a first part provided in the patient support device and a second part provided in the examination device. The first part is configured lockable with the second part. The second part includes a pair of vertically guiding surfaces positioned symmetrically with respect to a vertical plane through the examination device, wherein the distance between the guiding surfaces decreases further away from the examination device.

Although the above configuration eliminates the disadvantages of a hook mechanism, the number of components is large and also offers low reliability and high maintenance related problems.

Thus, these known devices have limitations and do not provide for a positioner docking device having (i) a configuration that does not require any tension setting, (ii) a mechanism free from problems of disengagement and deformation, (iii) a robust design that would withstand side loads without any misalignment; and (iv) high reliability and minimum maintenance.

### SUMMARY OF THE INVENTION

The above-mentioned shortcomings, disadvantages and problems are addressed herein which will be understood by reading and understanding the following specification.

In one embodiment, a positioner docking device for a medical imaging apparatus is provided. Accordingly, the device comprises at least one first docking part having at least one first guiding surface disposed in a gantry, at least one locking recess disposed in the first guiding surface, at least one second docking part having at least one second guiding surface, disposed in a positioner, at least one locking member coupled to at least one energizing means, disposed in the second guiding surface, wherein the first guiding surface and the second guiding surface are configured movable towards each other for mutual engagement, wherein upon engagement, the locking member is locked onto the locking recess for docking the positioner on to the gantry.

In another embodiment, a medical imaging apparatus is provided. Accordingly, the apparatus comprises at least one gantry, at least one positioner, a means for docking the positioner on to the gantry, wherein the means for docking comprises at least one hollow surface and at least one protruding surface configured movable towards each other for mutual engagement, and a means for locking the hollow surface and the protruding surface upon engagement.

In yet another embodiment, a docking assembly for a medical imaging apparatus is provided. The assembly comprises a docking cavity, a docking protrusion, a recess provided in at least one of the docking cavity and the docking protrusion, and a locking member configured for locking on to the recess.

Apparatus, systems and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 shows a top view of a medical imaging apparatus with a docking device in undocked state according to one embodiment;

FIG. 2 shows a top view of a medical imaging apparatus with a docking device in docked state according to one embodiment;

FIG. 3 shows a cross-section illustrating the docking assembly in a state of operation according to some embodiments;

FIG. 4 shows a cross-section of the docking assembly in docked state according to some embodiments; and

FIG. 5 shows a part cross-section of the docking assembly illustrating the locking member according to some embodiments.

### DETAILED DESCRIPTION OF THE INVENTION

In the following description, reference is made to the accompanying drawings that form a part hereof, and in which is shown by way of illustration, specific embodiments which may be practiced. These embodiments are described in sufficient detail to enable those skilled in the art to practice the embodiments, and it is to be understood that embodiments may be utilized and that logical, mechanical, electrical and other changes may be made without departing from the scope of the embodiments. The following detailed description is, therefore not to be taken in a limiting sense.

Various embodiments provide a positioner docking device for a medical imaging apparatus. However, the embodiments are not limited and may be implemented in connection with other imaging apparatus such as, industrial imaging apparatus.

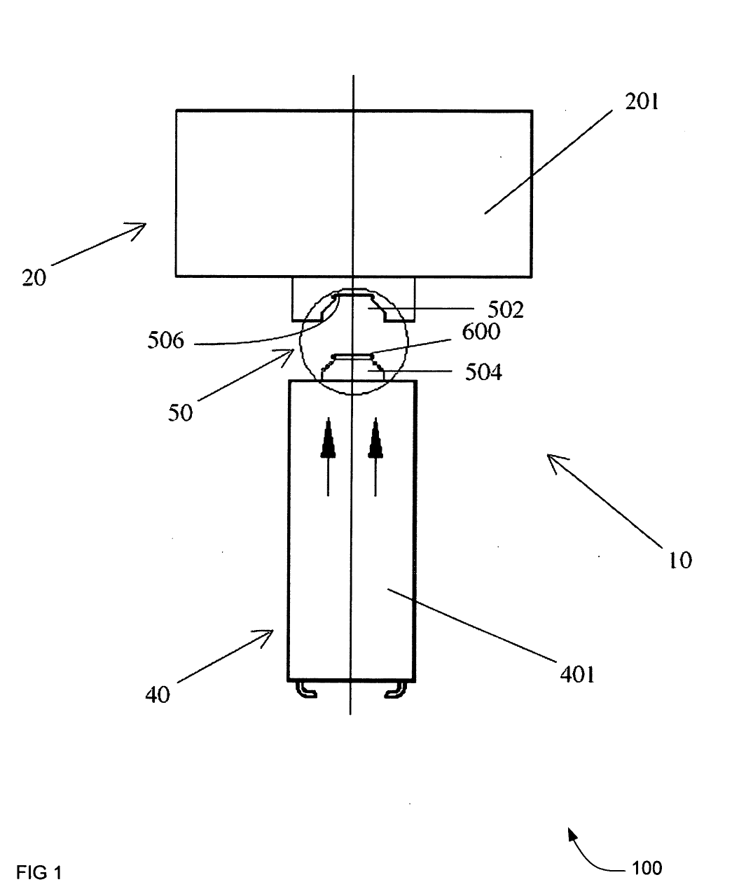

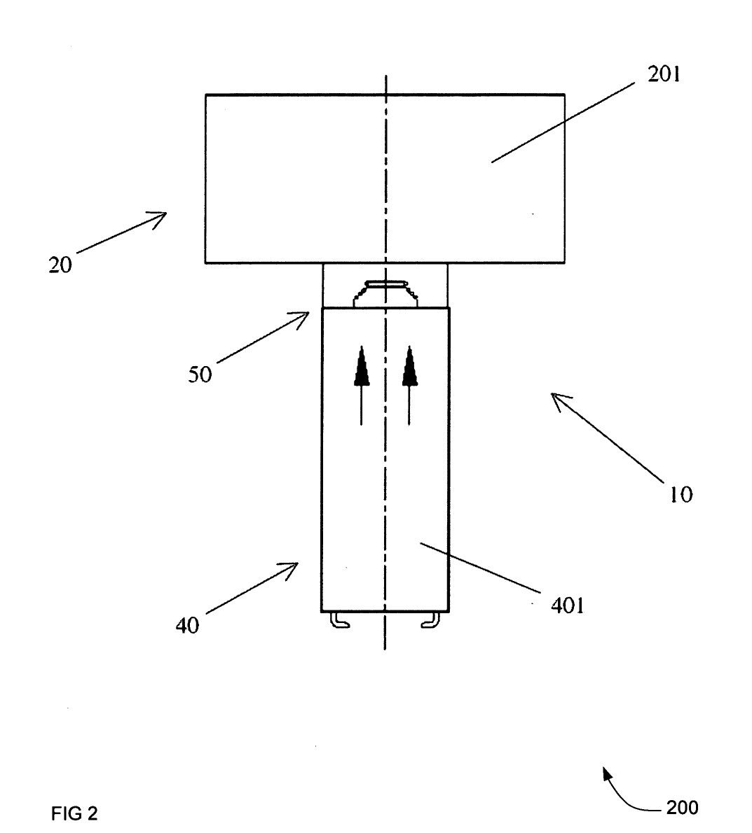

FIG. 1 and FIG. 2 show a top view of a medical imaging apparatus 10 configured having a docking assembly 50 according to one embodiment. Accordingly, the medical imaging apparatus 10 comprises at least one gantry 20 configured having a medical imaging part 201 such as, for example, a magnet for magnetic resonance imaging. At least one positioner 40 is provided having a patient support part 401 such as, for example, a trolley configured for carrying a patient in substantially horizontal position. The docking assembly 50 includes a docking cavity 502 configured in the gantry 20 and a docking protrusion 504 provided in the positioner 40. The positioner 40 is fixedly coupled to the gantry 20 at the time of medical imaging using the docking assembly 50. The positioner 40 is configured separable from the gantry 20 after medical imaging by operating the docking assembly 50.

A recess 506 is provided in the docking cavity 502. A locking member 600 is configured in the docking protrusion 504. The locking member 600 is configured for riding over the docking cavity 502 for locking on to the recess 506, thereby docking the positioner 40 on to the gantry 20.

In one example, the docking cavity 502 is configured having a substantially tapered surface. The docking protrusion 504 is configured having a surface substantially matching with the tapered surface. In another example, the docking cavity 502 is configured having a hollow surface. The docking protrusion 504 is configured having a protruding surface wherein the protruding surface and the hollow surface are configured movable towards each other for mutual engagement.

In another embodiment (not shown), the docking cavity 502 is provided in the positioner 40 and the docking protrusion 504 is provided in the gantry 20.

In a further embodiment (not shown) the recess 506 is configured in the docking protrusion 504. The locking member 600 is provided in the docking cavity 502. The locking member 600 is configured for riding over the docking protrusion 504 and locking on to the recess 506.

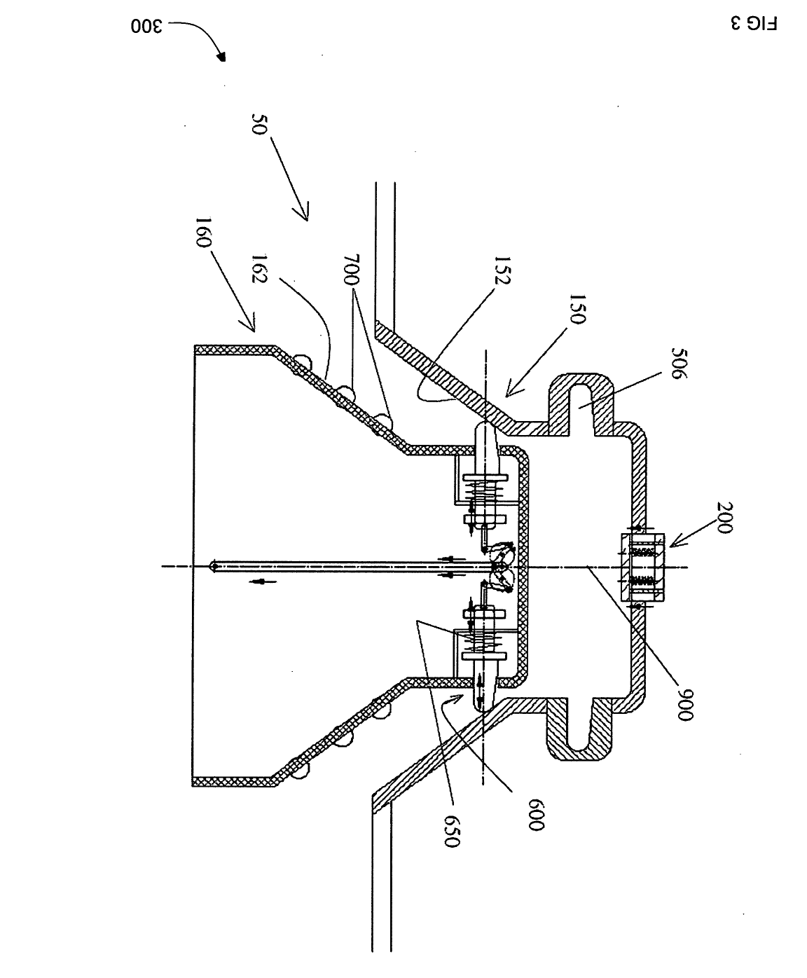

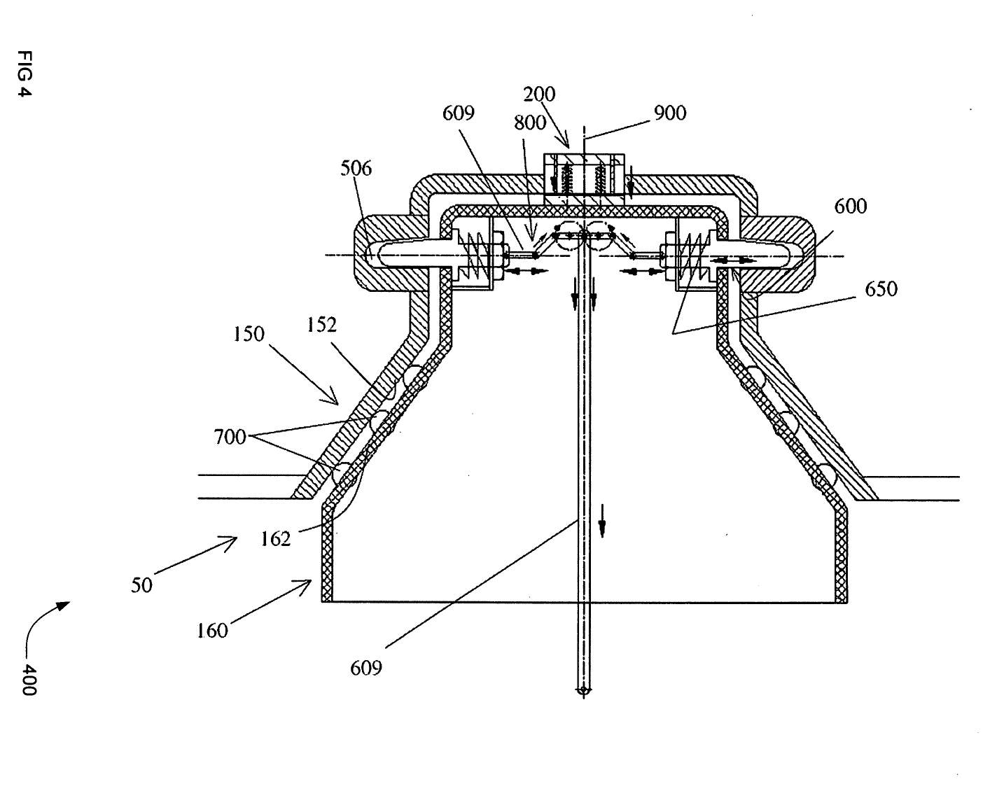

FIG. 3 and FIG. 4 show the docking assembly 50 in docked and undocked states according to some embodiments. The docking assembly 50 comprises a first docking part 150 having at least one first guiding surface 152. The recess 506 is provided in the first guiding surface 152. The first docking part 150 is disposed in the gantry (not shown). A second docking part 160 is configured having at least one second guiding surface 162. The second docking part 160 is provided in the positioner (not shown). The locking member 600 is coupled to an energizing means 650 and is mounted on to the second guiding surface 162. The first guiding surface 152 and the second guiding surface 162 are configured movable towards each other for mutual engagement, wherein upon engagement, the locking member 600 is locked on to the recess 506, thus docking the positioner 40 on to the gantry 20.

In an example, the first guiding surface 152 comprises a substantially conical shape. The second guiding surface 162 comprises a shape substantially matching with the shape of the first guiding surface 152.

It should be noted that a substantially conical shape is configured for the first guiding surface 152 for facilitating the smooth entry of the locking member 600 in to the first guiding surface 152 for locking on to the recess 506. However, other shapes such as, concave, a taper rod shape, a trapezoidal bar shape, a rectangular bar, etc, that facilitate smooth entry of locking member 600 are also possible for the first guiding surface 152.

A plurality of rolling elements 700 is configured in the second guiding surface 162. For example, the rolling elements 700 may include at least one of rollers and balls rollably embedded in the second guiding surface 162.

It should be noted that the rolling elements 700 facilitate guiding the locking member 600 and the second guiding surface 162 along the longitudinal positioner axis 800, towards the recess 506 in the first guiding surface 152, without substantial lateral movement of the second guiding surface 162. Other embodiments, wherein the rolling elements 700 are configured on the first guiding surface 152 are also possible.

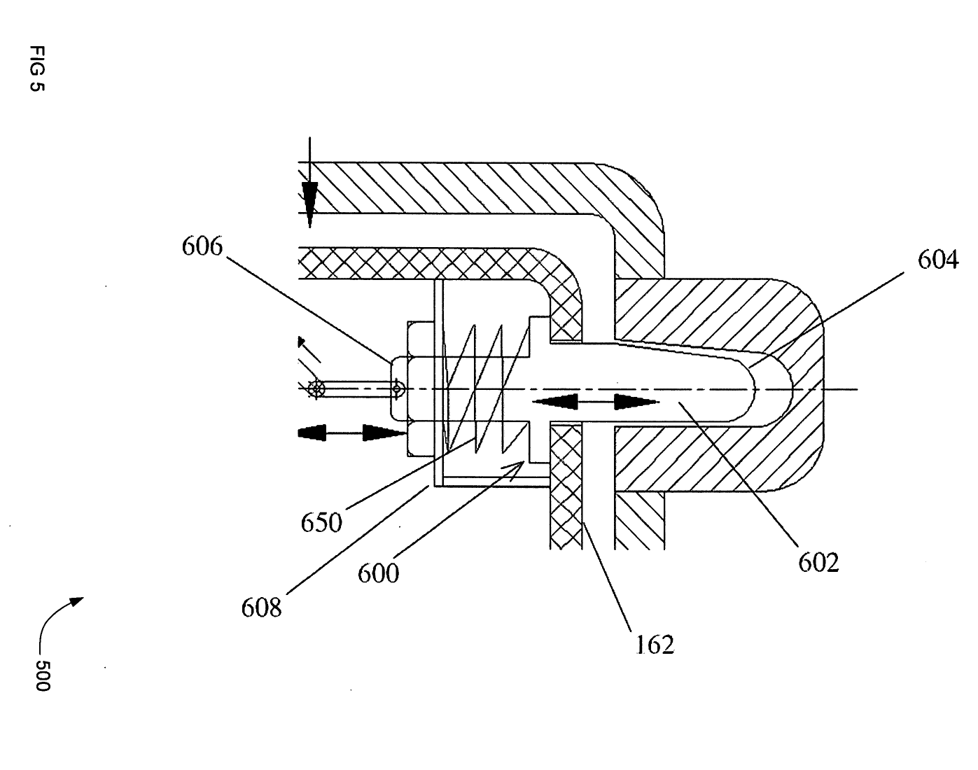

In some embodiments (see FIG. 5), the locking member 600 comprises at least one locking bar 602 configured energized by an energizing means 650 such as, a spring. The locking bar 602 comprises a first end 604 and a second end 606. The locking bar 602 is disposed on a bracket 608 such that the first end 604 projects out from the second guiding surface 162. The second end 606 is coupled to an elongate lever 609 (see FIG. 4). The elongate lever 609 is coupled to an undocking means through a link mechanism 800.

In one example of docking operation, the positioner 40 is pushed manually towards the gantry 20, wherein the second guiding surface 162 is guided into the first guiding surface 152 (see FIG. 3 and FIG. 4). At the time of guiding, the projecting locking bar 602 (see FIG. 5) rides over the first guiding surface 152, and the energizing means 650 is compressed as long as the locking bar 602 is in contact with the first guiding surface 152. As the locking bar 602 reaches the recess 506, the energizing means 650 gets decompressed, thereby automatically locking the locking bar 602 onto the recess 506. Thus, the positioner 40 is docked on to the gantry 20 by manually pushing the positioner 40 towards the gantry 20.

In an example (see FIG. 3 and FIG. 4), the first guiding surface 152 and the second guiding surface 162 are configured symmetrical about a vertical plane 900, with the locking bars 602 configured symmetrical about the vertical plane.

In some embodiments, a reaction element 200 (see FIG. 4) is configured in the first guiding surface 152 for facilitating undocking operation. For example, the reaction element 200 may include a bush constructed from an elastic material such as, rubber or an elastomer that exerts an undocking force on the second guiding surface 162.

In an example of an undocking operation, the undocking means such as, a pedal is pressed, wherein the locking bar 602 (see FIG. 4) moves out of the recess 506. Once the locking bar 602 is out of the recess 506, the undocking force by the reaction element 200 facilitates separation of the second guiding surface 162 from the first guiding surface 152 thereby undocking the positioner 40 and the gantry 20.

It should be noted that the purpose of the reaction element 200 is to facilitate undocking of the positioner 40 and the gantry 20. The undocking force may also be generated against the first guiding surface 152 by configuring the reaction element 200 in the second guiding surface 162 instead of the first guiding surface 152.

It should also be noted that the docking operation according to some embodiments includes just manually pushing the positioner 40 towards the gantry 20 thereby facilitating automatic docking operation without having need for a docking pedal. For undocking operation, the undocking means such as pedal is pressed to remove the locking bar 602 out of the recess 506.

In some embodiments shown in FIG. 5, the locking bar 602 comprises at least one first tapering surface 61 and the recess 506 comprises at least one second tapering surface 63. The first end 604 of the locking bar 602 is configured having a substantially hemi-spherical surface. The required compression of the energizing means 650 and required locking force are generated by appropriately selecting the length of the locking bar 602. This configuration of the locking bar 602 provides sufficient riding friction relative to the first guiding surface 152 and a sufficient locking friction for locking on to the recess 506 without any slippage.

It should be noted that the docking device according to some embodiment does not require any tension setting as the docking operation is carried out by gently pushing the positioner 40 towards the gantry 20 and undocking operation may be carried out by operating a single pedal. Noise generation is absent as there is no requirement of tension setting operation and the docking operation is simplified due to absence of pedal that may require substantial physical force for operation.

The docking device according to some embodiment provides improved stability as the rolling elements 700 are configured to facilitate docking operation without substantial lateral guiding movement. The docking device according to some embodiments provides a safe docking operation as undocking is possible only by operating the pedal manually.

The docking device according to some embodiment provides improved safety as the locking bars 602 are configured in symmetrical fashion to prevent accidental undocking of the positioner 40 and the gantry 20.

Thus, various embodiments of some embodiments provide a positioner docking device for a medical imaging apparatus. Some embodiments provide a medical imaging apparatus.

While the docking device has been described with various specific embodiments, it will be obvious for a person skilled in the art to practice the invention with modifications. However, all such modifications are deemed to be within the scope of the claims.

What is claimed is:

1. A positioner docking device for a medical imaging apparatus, comprising:
(i) at least one first docking part having at least one first guiding surface, disposed in a gantry;
(ii) at least one recess disposed in the first guiding surface;
(iii) at least one second docking part having at least one second guiding surface, disposed in a positioner; and
(iv) at least one locking member coupled to at least one energizing means, disposed in the second guiding surface, wherein:
the first guiding surface and the second guiding surface are configured movable towards each other for mutual engagement, wherein upon engagement, the locking member is locked onto the recess for docking the positioner on to the gantry.

2. The docking device according to claim 1 further comprising a plurality of rolling elements mounted to at least one of the first guiding surface and the second guiding surface.

3. The docking device according to claim 1 further comprising at least one elongated lever coupled to the locking member.

4. The docking device according to claim 3 further comprising at least one undocking member coupled to the elongated lever.

5. The docking device according to claim 1 further comprising at least one reaction element coupled to at least one of the first guiding surface and the second guiding surface.

6. The docking device according to claim 1 further comprising at least one first tapering surface on the locking member.

7. The docking device according to claim 1 further comprising at least one second tapering surface on the recess.

8. The docking device according to claim 7 wherein the locking member further comprises a substantially spherical end surface.

9. The docking device according to claim 1 wherein the first guiding surface further comprises a substantially conical shape.

10. The docking device according to claim 1 wherein the second guiding surface further comprises a shape configured for substantially matching the conical shape.

11. A medical imaging apparatus, comprising:
(i) at least one gantry configured having an imaging part;
(ii) at least one positioner configured having a patient support part;
(iii) a means for docking the positioner on to the gantry; and
(iv) said means for docking further comprising:
(a) at least one hollow surface and at least one protruding surface configured movable towards each other for mutual engagement; and
(b) a means for locking the hollow surface and the protruding surface upon engagement.

12. The apparatus according to claim 11 wherein the means for docking further comprises a plurality of rolling members configured in at least one of the hollow surface and the protruding surface.

13. The apparatus according to claim 11 further comprising at least one undocking means coupled to the locking means.

14. The apparatus according to claim 11 further comprising at least one reaction element coupled to at least one of the hollow surface and the protruding surface.

15. The apparatus according to claim 11 wherein the locking means further comprising a locking member coupled to an energizing member.

16. The apparatus according to claim 15 wherein the locking member further comprising a configuration dimensioned to provide a predetermined riding friction and locking friction.

17. A docking assembly for a medical imaging apparatus, comprising:
(i) a docking cavity;
(ii) a docking protrusion;
(iii) a recess provided in at least one of the docking cavity and the docking protrusion; and
(iv) a locking member configured for riding over at least one of the docking cavity and the docking protrusion for locking on to the recess.

18. The docking assembly according to claim 17 wherein the docking cavity is further comprises a substantially tapered surface.

19. The docking assembly according to claim 18 wherein the docking protrusion further comprises a surface substantially matching the tapered surface.

20. The docking assembly according to claim 17 further comprises a reaction element provided in at least one of the docking cavity and the docking protrusion.
